(19) United States
(12) Patent Application Publication
(10) Pub. No.: US 2016/0015013 A1
(43) Pub. Date: Jan. 21, 2016

(54) Fishing Lure

(71) Applicant: Don Talbot, Wenatchee, WA (US)

(72) Inventor: Don Talbot, Wenatchee, WA (US)

(21) Appl. No.: 14/335,722

(22) Filed: Jul. 18, 2014

(51) Int. Cl. A01K 85/10; A01K 85/01

(52) U.S. Cl. CPC A01K 85/10; A01K 85/01

(57) ABSTRACT

The instant application discloses, among other things, a Fishing Lure. The spinner blades of Fishing Lure may be configured to generate more action, such as vibration, flash, lift, and spin than conventional spinner blades. In one embodiment, the wings of the spinner blade may be unequal in size, producing an uneven wobble when the lure moves through water. In another embodiment, a friction-reducing post may be inserted through an aperture in the spinner blade to reduce wear and tear on the fishing line. In yet another embodiment, the spinner blade of Fishing Lure may include a plurality of notches that form creases at any angle in the blade to help generate spin.

### FIELD

This disclosure relates generally to a Fishing Lure.

### BACKGROUND

Fishermen may use different types of lures to attract various types of fish in diverse habitats. A spinnerbait refers to a fishing lure with one or more blades, called spinner blades, attached to the lure. As a spinnerbait moves through water, the blades rotate, creating varying degrees of vibration (the thump created when the blade spins), flash (the light that reflects off of the blade as it moves), lift, and spin, for instance. The action of the spinner blade may affect a lure's ability to attract fish, for example, by resembling wounded prey.

### SUMMARY

The instant application discloses, among other things, a Fishing Lure. The spinner blades of Fishing Lure may be configured to generate more action, such as vibration, flash, lift, and spin than conventional spinner blades.

In one embodiment, the wings of the spinner blade may be unequal in size, producing an uneven wobble when the lure moves through water. In another embodiment, a friction-reducing post may be inserted through an aperture at the center of the spinner blade to prevent uneven friction from the rotating blade from damaging the fishing line.

In yet another embodiment, the spinner blade of Fishing Lure may include a plurality of notches that form creases at any angle in the blade to help generate spin. The notches may also direct fishermen in realigning the blade should it bend out of shape.

A person skilled in the art will appreciate that Fishing Lure may be used in combination with one or more other fishing devices. It may be made of any material such as metal, plastic, rubber, silicone, wood, carbon fiber, or Mylar, for example. Fishing Lure may have various shapes, sizes, and textures; for instance, the spinner blades may have a smooth or hammered finish, or a combination.

### BRIEF DESCRIPTION OF THE DRAWINGS

FIG. 1 illustrates a Fishing Lure according to one embodiment.

FIG. 2 illustrates spinner blades of Fishing Lure according to another embodiment.

FIG. 3 illustrates spinner blades of Fishing Lure according to another embodiment.

FIG. 4 illustrates spinner blades of Fishing Lure according to another embodiment.

FIG. 5 illustrates spinner blades of Fishing Lure according to another embodiment.

FIG. 6 illustrates spinner blades of Fishing Lure according to another embodiment.

FIG. 7 illustrates spinner blades of Fishing Lure according to another embodiment.

FIG. 8 illustrates spinner blades of Fishing Lure according to another embodiment.

### DETAILED DESCRIPTION

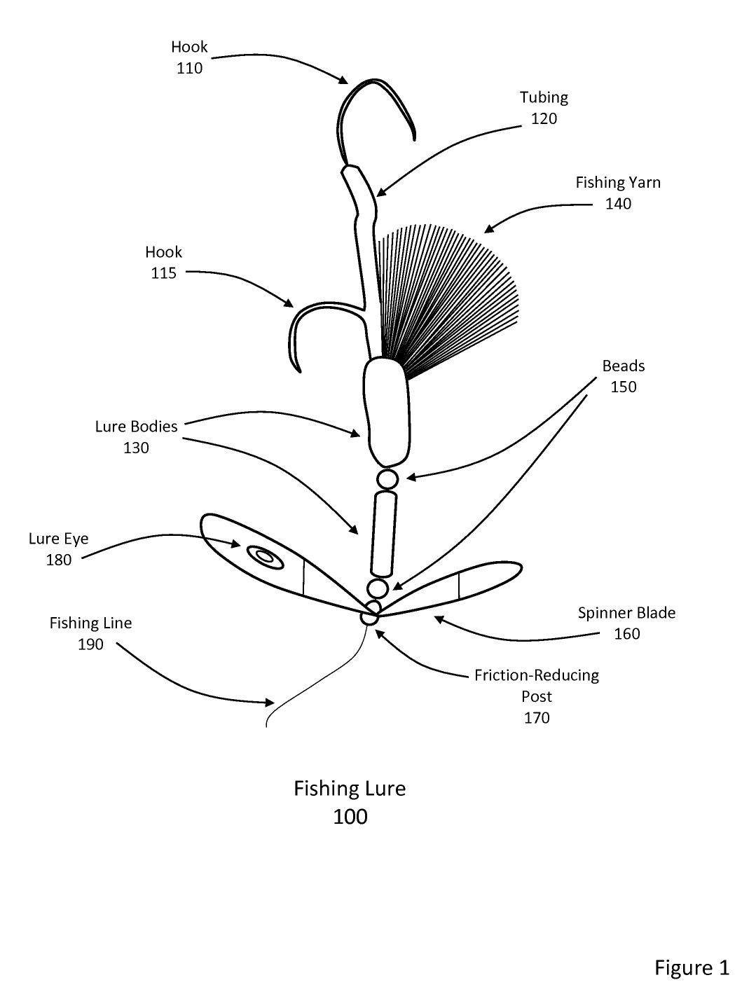

FIG. 1 illustrates a Fishing Lure 100 according to one embodiment. In this example, Fishing Lure 100 may include a single or plurality of hooks, for example, Hook 110 and Hook 115, which may attach to Fishing Line 190. Tubing 120, such as shrink wrap, may secure Hook 110 and Hook 115 to Fishing Line 190. Fishing Lure 100 may include any type and combination of functional and aesthetic objects such as Lure Bodies 130, Fishing Yarn 140, and Beads 150, for example, which may attach directly to Fishing Line 190 or to a wire shaft, for instance.

Fishing Lure 100 may include at least one Spinner Blade 160. In this example, Spinner Blade 160 may include two wings that are different in size from each other. The size disparity of the Spinner Blade 160 wings may produce an uneven wobble in Fishing Lure 100 when it moves through water; for example, when it trolls or drifts. The uneven wobbling action may enhance a lure's effectiveness in attracting fish by influencing the vibration, flash, lift, spin, or movement produced, or any other characteristics. Spinner Blade 160 may have a smooth or hammered finish, or a combination. It may also include or combine with any functional and aesthetic objects such as Lure Eye 180, for example.

Friction-Reducing Post 170 may be inserted in an aperture at the center of Spinner Blade 160, or any other location, to reduce the uneven fiction of Spinner Blade 160 on Fishing Line 190. Friction-Reducing Post 170 may help prevent wear and tear of Fishing Line 190. Friction-Reducing Post 170 may be made of plastic or any other material. The more action that Fishing Lure 100 may produce, the more friction-reducing length of post may be used, which may reduce line wear.

A person skilled in the art will appreciate that Fishing Lure 100 may be used in combination with one or more other fishing devices. Fishing Lure 100 and its components may be made of any material such as metal, plastic, rubber, silicone, wood, carbon fiber, or Mylar, for example, and it may have various shapes, sizes, and textures. Fishing Lure 100 and its components may be any color including, for example, colors in the visible light spectrum, ultraviolet colors, or fluorescent colors.

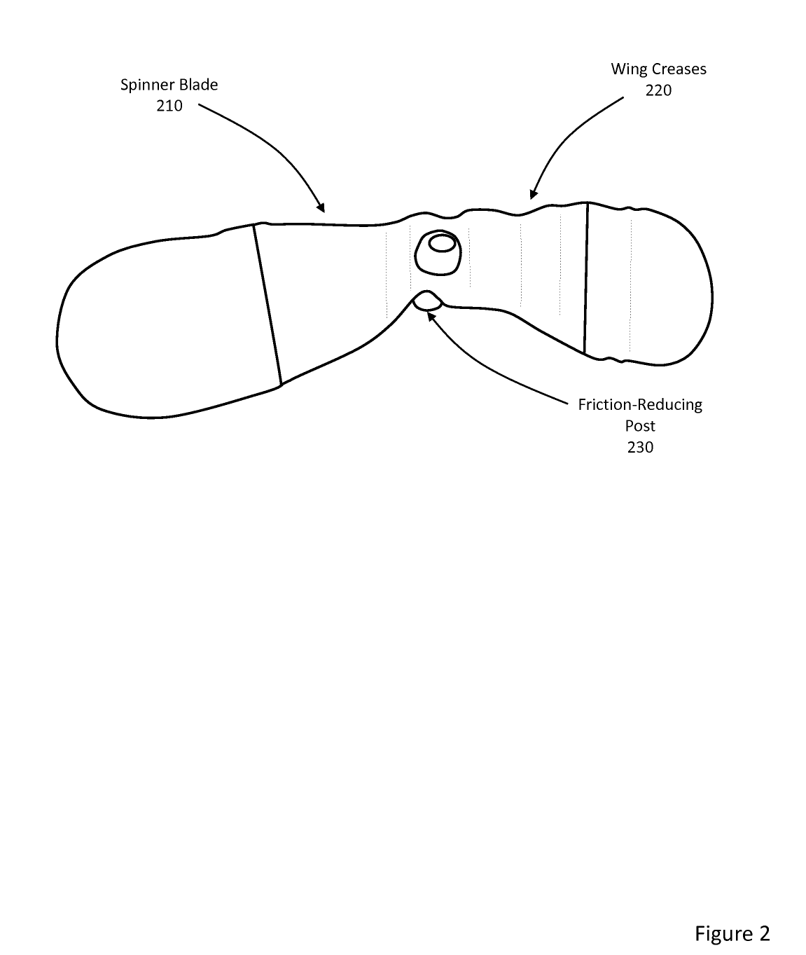

FIG. 2 illustrates spinner blades of Fishing Lure according to another embodiment. In this example, Spinner Blade 210 may comprise a pair of wings having a single or plurality of Wing Creases 220, which may affect the spinning or wobbling action of Fishing Lure, for instance, or any other characteristics. The Wing Creases 220 may represent symmetrical or asymmetrical waves, for example. Friction-Reducing Post 230 may be inserted in an aperture of Spinner Blade 210 to reduce the uneven friction on a fishing line.

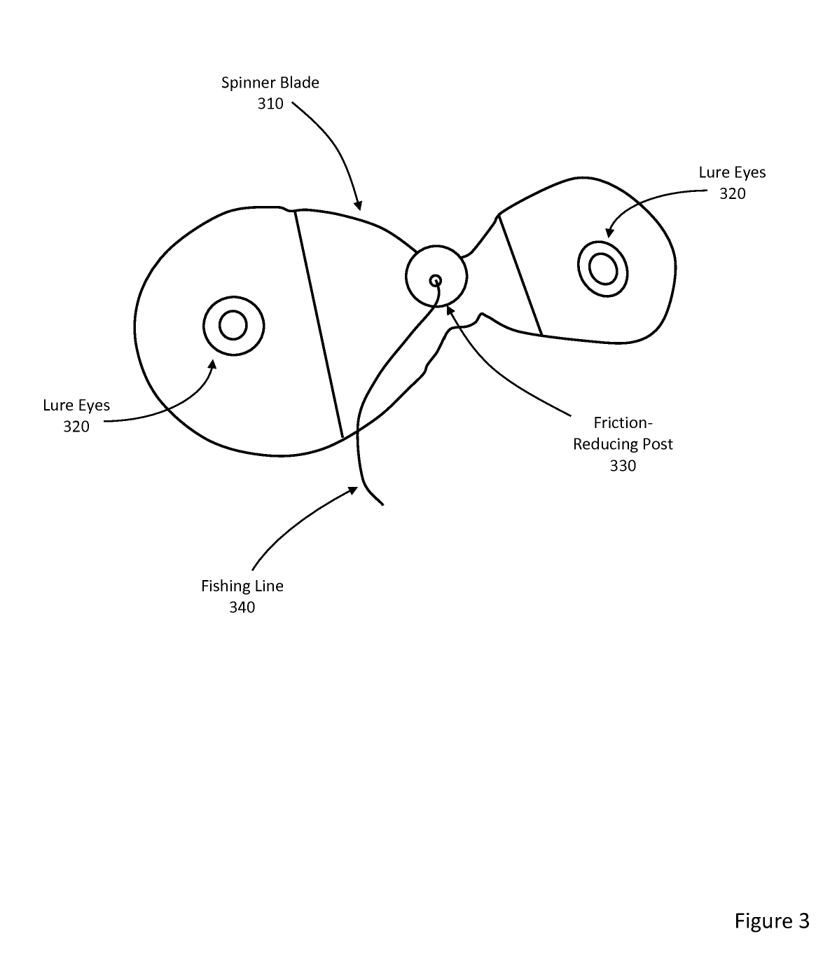

FIG. 3 illustrates spinner blades of Fishing Lure according to another embodiment. In this example, Spinner Blade 310 may comprise two teardrop-shaped wings that are different sizes. Spinner Blade 310 may include any functional or aesthetic objects such as Lure Eyes 320 to help attract fish. Friction-Reducing Post 330 may pass through an aperture of Spinner Blade 310 to reduce friction on Fishing Line 340.

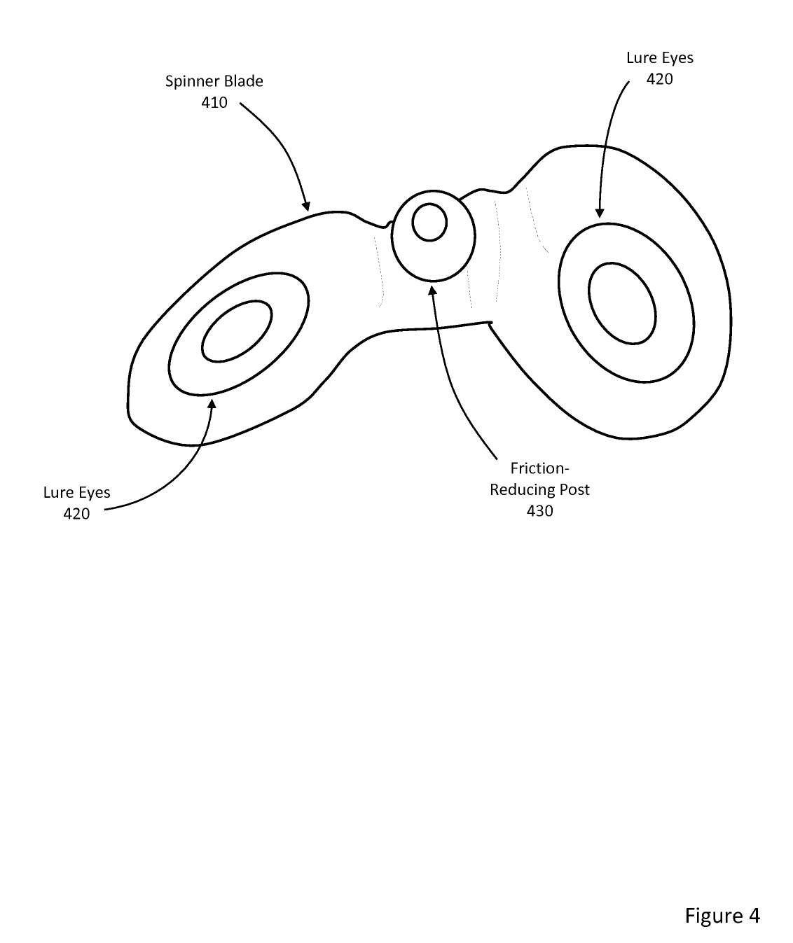

FIG. 4 illustrates spinner blades of Fishing Lure according to another embodiment. In this example, Spinner Blade 410 may comprise two round wings, one of which is larger than the other. Spinner Blade 410 may bend at any point on its surface to affect spin and other characteristics when Fishing Lure moves through water. Spinner Blade may also include Lure Eyes 420 and Friction-Reducing Post 430 to protect a fishing line of the Fishing Lure.

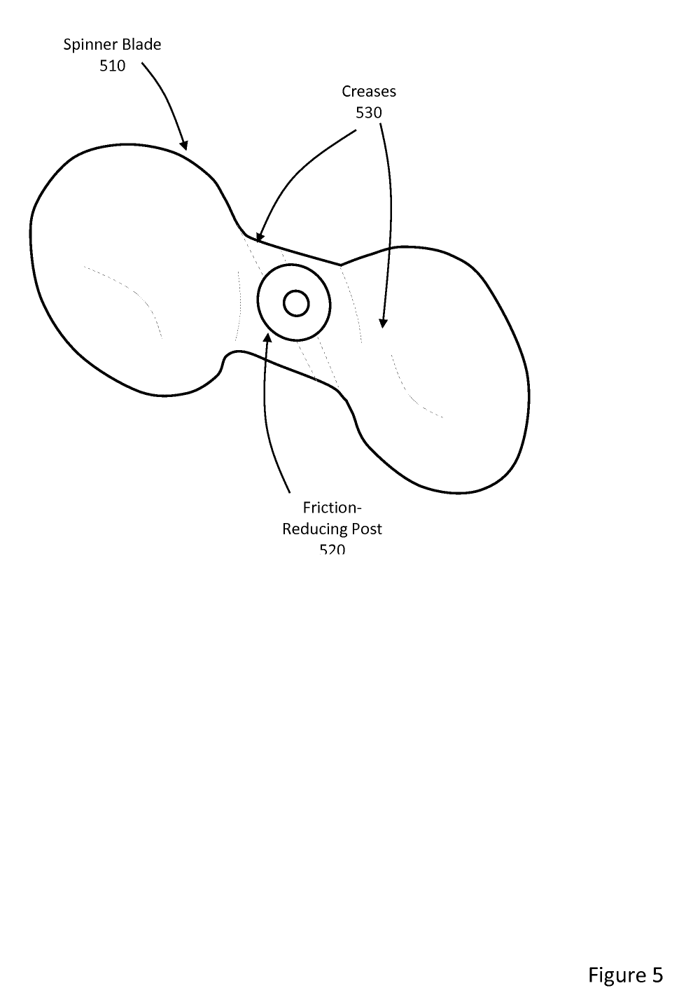

FIG. 5 illustrates spinner blades of Fishing Lure according to another embodiment. In this example, Spinner Blade 510 includes a plurality of Creases 530 in various parts along its surface. Creases 530 may affect spin and other characteristics of Fishing Lure as it moves through water. Insert Post 520 may also pass through Spinner Blade 510.

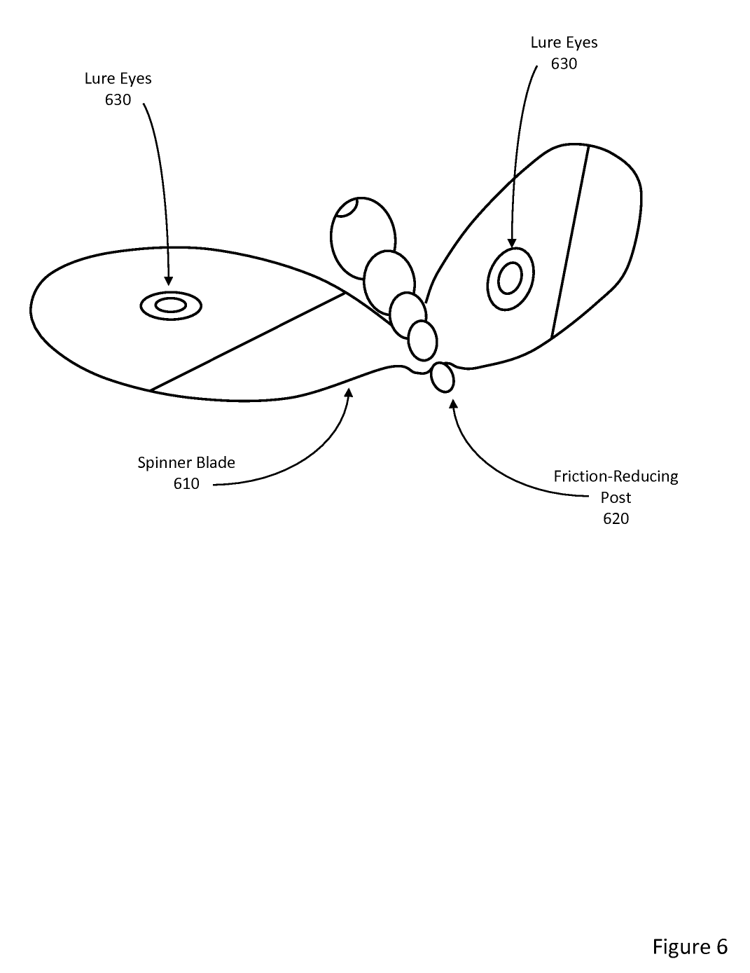

FIG. 6 illustrates spinner blades of Fishing Lure according to another embodiment. Spinner Blade 610 may comprise two wings that are different in size to produce an uneven wobbling action when Fishing Lure moves through water. Each wing of Spinner Blade 610 may be adorned with Lure Eyes 630. In this example, Spinner Blade 610 may be configured to produce greater action and thus may require a longer Friction-Reducing Post 620 to prevent line wear.

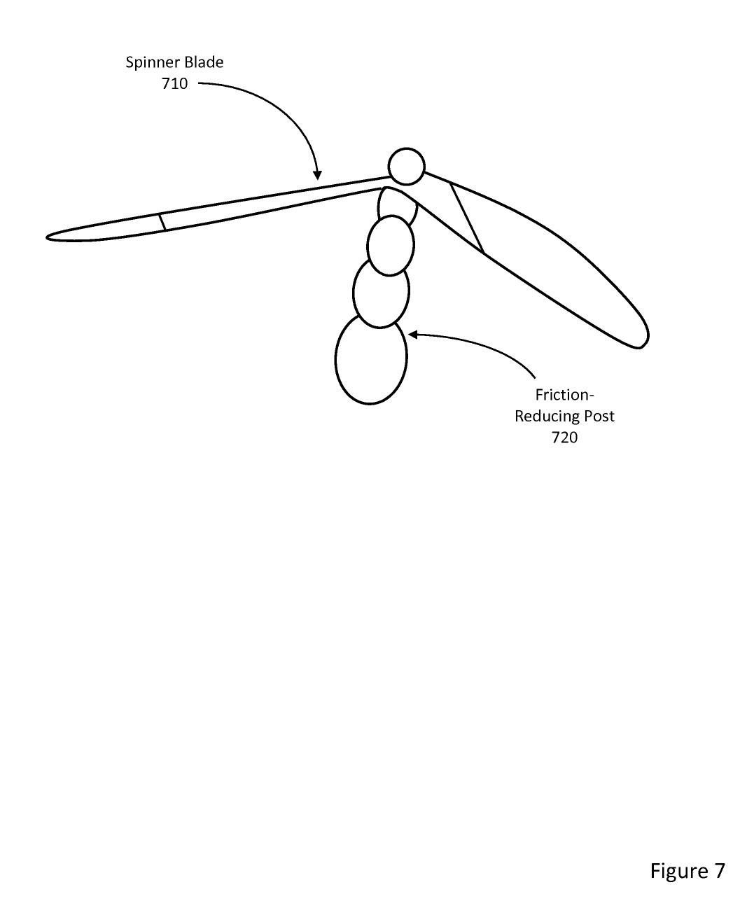

FIG. 7 illustrates spinner blades of Fishing Lure according to another embodiment. In this example, Spinner Blade 710 may include wings that bend at any angle to affect the spin, left, or other characteristics of Fishing Lure. The wings of Spinner Blade 710 may different in length and width. Friction-Reducing Post 720 may pass through Spinner Blade 710 to protect a fishing line from the uneven friction created by Spinning Blade 710's wobbling action.

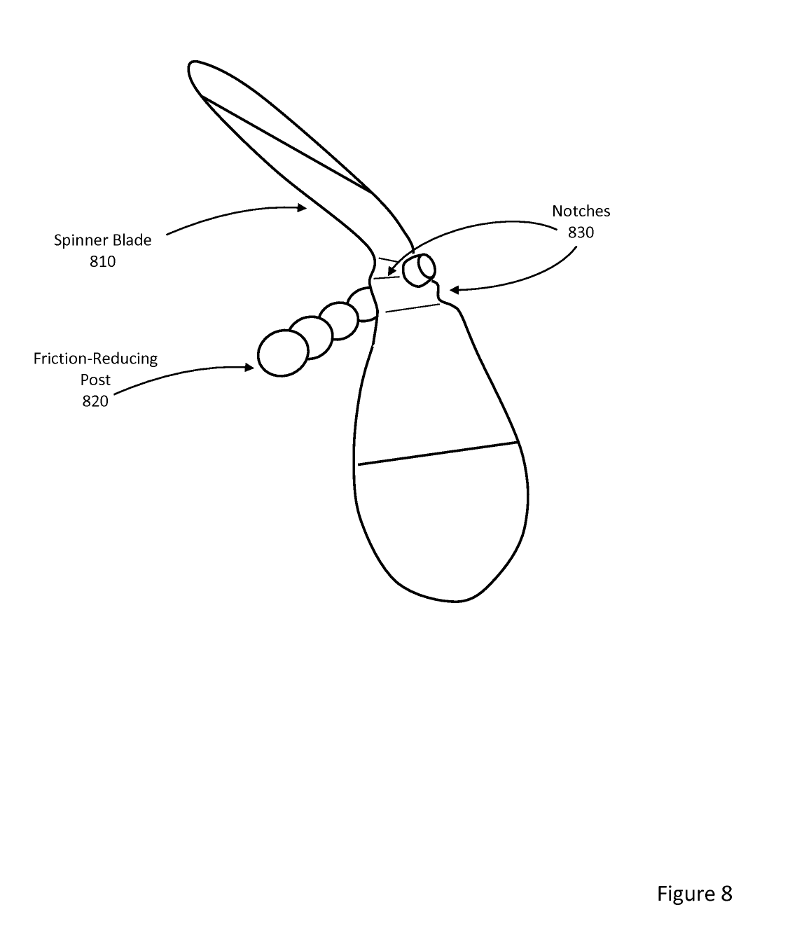

FIG. 8 illustrates spinner blades of Fishing Lure according to another embodiment. In this example, Spinner Blade 810 may have a single or plurality of Notches 830, for example, at the center of Spinner Blade 810 or any other location. Notches 830 may form creases in the blade at any angle to help generate spin, for instance. The Notches 830 may also direct fishermen in realigning the blade should it bend out of shape. Friction-Reducing Post 820 may pass through an aperture of Spinner Blade 810 to reduce friction on a fishing line.

1. A Fishing Lure, comprising:
a hook;
a spinner blade;
a friction-reducing post, the friction-reducing post passing through an aperture in spinner blade;
a fishing line.

2. The Fishing Lure of claim 1, wherein the hook comprises any type of the list containing single hook, double hook, and treble hook.

3. The Fishing Lure of claim 1, wherein the sections of spinner blade material on either side of the fishing line is unequal in size.

4. The Fishing Lure of claim 1, wherein the spinner blade has at least one notch to create at least one crease.

5. The Fishing Lure of claim 1, wherein the spinner blade is made of any material from the list containing metal, plastic, rubber, silicone, wood, carbon fiber, and Mylar.

6. The Fishing Lure of claim 1, wherein at least a portion of the spinner blade has a smooth surface.

7. The Fishing Lure of claim 1, wherein at least a portion of the spinner blade has a hammered surface.

8. The Fishing Lure of claim 1, wherein the spinner blade reflects at least a portion of ultraviolet light to which it is exposed.

9. The Fishing Lure of claim 1, wherein the spinner blade has a fluorescent color.

10. The Fishing Lure of claim 1, the friction-reducing post is made of a material from the list containing metal, plastic, rubber, silicone, wood, carbon fiber, and Mylar.
